(19) United States
(12) Patent Application Publication
(10) Pub. No.: US 2025/0267534 A1
(43) Pub. Date: Aug. 21, 2025

(54) METHOD AND APPARATUS FOR ENHANCED RLF HANDLING IN WIRELESS SYSTEMS

(71) Applicant: InterDigital Patent Holdings, Inc., Wilmington, DE (US)

(72) Inventors: Oumer Teyeb, Montreal (CA); Yugeswar Deenoo Narayanan Thangaraj, Chalfont, PA (US); Filipe Conceicao, London (GB)

(73) Assignee: InterDigital Patent Holdings, Inc., Wilmington, DE (US)

(21) Appl. No.: 18/859,143

(22) PCT Filed: Apr. 26, 2023
(86) PCT No.: PCT/US2023/019981

§ 371 Date: Oct. 22, 2024

Related U.S. Application Data
(60) Provisional application No. 63/335,016, filed on Apr. 26, 2022.

(51) Int. Cl. H04W 36/00; H04L 41/5003

(52) U.S. Cl. CPC H04W 36/0079; H04L 41/5003

(57) ABSTRACT

A method implemented by a remote wireless transmit receive unit (WTRU) related to determining to defer a radio link failure (RLF) and/or defer implementation of recovery after an RLF. The WTRU may receive configuration information from a network including a plurality of RLF specific parameters that are used to determine whether RLF has occurred. The WTRU may select an RLF specific parameter of the plurality of RLF specific parameters based on one or more determined or predicted channel conditions and conditions of the WTRU associated with radio link management (RLM). The WTRU may determine that RLF has occurred based on the selected RLF specific parameters and the one or more conditions. The WTRU may send an indication to the network based on determining one or more of the RLF detection or the RLF recovery behavior.

### CROSS-REFERENCE TO RELATED APPLICATIONS

This application claims the benefit of U.S. Provisional Patent Application No. 63/335,016, filed Apr. 26, 2022, the disclosure of which is incorporated herein by reference in its entirety.

### BACKGROUND

A wireless transmit/receive unit (WTRU) that is in radio resource control (RRC) connected (RRC_CONNECTED) needs to continuously monitor the radio link for ensuring the link is good/reliable enough for communication, a process referred to as Radio Link Monitoring (RLM). The WTRU monitors the downlink (DL) quality based on the reference signal that is being broadcasted from the serving cell.

The WTRU may configure which RLM reference signals (RLM-RS) to monitor in order to determine the radio quality of the primary cell (PCell) and the secondary cell group (SCG), referred to as PSCell, in case of dual connectivity (DC). The network may configure the WTRU to perform the RLM based on SSB (Synchronization Signal Block), CSI-RS (Channel State Information-Reference Signal), or a combination of the two. Various timers and counters may be used to determine the reliability of the link. At the expiration of these timers and counters, the RRC will consider the link to have failed and declare a Radio Link Failure (RLF). Once a RLF is declared, a reestablishment procedure may be implemented.

Due to varying operating conditions (activity level, mobility state, trajectory, etc.) for multiple WTRUs connected to the network, it may be impractical for the network to separately keep track and to separately handle the RLF detection and RLF recovery procedures.

### SUMMARY

A wireless transmit/receive unit (WTRU) may be configured to modify RLF detection and RLF recovery behavior based on current and predicted WTRU data activity (e.g., configured bearers, data activity, etc.), current and predicted mobility level, location, and time. The WTRU may apply a radio link failure (RLF) detection and recovery behavior that is dependent on current/predicted WTRU traffic/trajectory in addition to network/radio conditions.

A remote WTRU may determine to defer a radio link failure (RLF) and/or defer implementation of recovery after an RLF. The WTRU may receive configuration information from a network including a plurality of RLF specific parameters that are used to determine whether RLF has occurred. The WTRU may detect (e.g., determine) one or more parameters of the plurality of RLF specific parameters based on one or more determined or predicted channel conditions and conditions of the WTRU associated with radio link management (RLM). The WTRU may determine that RLF has occurred based on the detected RLF specific parameter(s) and/or the one or more conditions. The WTRU may send an indication to the network based on determining the RLF detection and/or the RLF recovery behavior.

the determined conditions of the WTRU may include one or more of configured radio bearers, quality of service (QOS) settings of the configured radio bearers, a current data activity level of the configured radio bearers, a predicted data activity level of the configured radio bearers, a mobility state of the WTRU, a speed of the WTRU, a WTRU location, a predicted WTRU location, a WTRU trajectory, or a predicted WTRU trajectory. The determination to defer sending an RLF indication or report may be based on the selected RLF specific parameters and/or the determined channel conditions.

The WTRU may send RLF information to the network. The RLF information may include one of more of a deferral cause, a time taken to recover the RL, one or more measurements at the time of RLF, one or more measurements as the time of RL recovery, a WTRU location at the time of the RLF, a WTRU location at the time of RL recovery, a time associated with RLF detection, or a time associated with RL recovery. The plurality of RLF specific parameters may include one or more of an RLF counter, an RLF constant, an RLF timer, or an RLF threshold. The detected RLF specific parameters may be modified based on the one or more conditions of the WTRU.

The one or more measured/determined channel conditions related to RLM may include one of more of an RLM reference signal (RLM-RS) or an out of sync indication. The WTRU may determine to perform RLF recovery based on one or more of the channel conditions related to RLM, the one or more conditions of the WTRU, predicted channel conditions, and/or predicted conditions of the WTRU. for the WTRU determining whether to perform RLF recovery, may include determining whether to defer re-establishment based on one or more conditions of the network and the WTRU. The conditions may include on one or more of the channel conditions related to RLM, the conditions of the WTRU, predicted channel conditions, and/or predicted conditions of the WTRU. The WTRU may predict the one or more of the channel conditions and the conditions of the WTRU based on historical data related to one or more channel conditions and/or conditions of one or more WTRUs operating within the network.

The WTRU may receive RLF configuration information from the network. The RLF configuration information may include a one or more RLF specific parameters used to determine whether RLF has occurred. The WTRU may determine one or more conditions of the WTRU and/or determines one or more RLF specific parameters based on the conditions of the WTRU. to the WTRU may determine one or more RLF specific parameters based on one or more channel conditions associated with radio link management (RLM). of the WTRU may determine RLF detection and/or RLF recovery behavior based on the selected RLF specific parameter(s) and/or channel conditions. The WTRU may send an indication to the network based on determining the RLF detection or RLF recovery behavior. The conditions of the WTRU may include one or more configured radio bearers, quality of service (QOS) settings of the radio bearers, a current data activity level of the configured radio bearers, a predicted data activity level of the configured radio bearers, a mobility state of the WTRU, a speed of the WTRU, a WTRU location, a predicted WTRU location, a WTRU trajectory, and/or a predicted WTRU trajectory.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example Core Network (CN) that may be used within the communications system illustrated in FIG. 1A according to an embodiment.

FIG. 2 illustrates various timers and counters that are used to determine the reliability of the link being monitored within RLM and RLF detection mechanisms.

FIG. 3 illustrates a high-level overview of the re-establishment procedure after an RLF.

FIGS. 4 and 5 illustrate examples of IE timers and constants used in the detection of and recovery from radio link problems.

FIG. 6 illustrates an example of the handling of RLFs.

FIG. 7 illustrates a combination of various solutions for deferred RLF handling and modified RLF recovery.

FIG. 8 is a further illustration of the combination of solutions for RLF and recovery handling.

### DETAILED DESCRIPTION

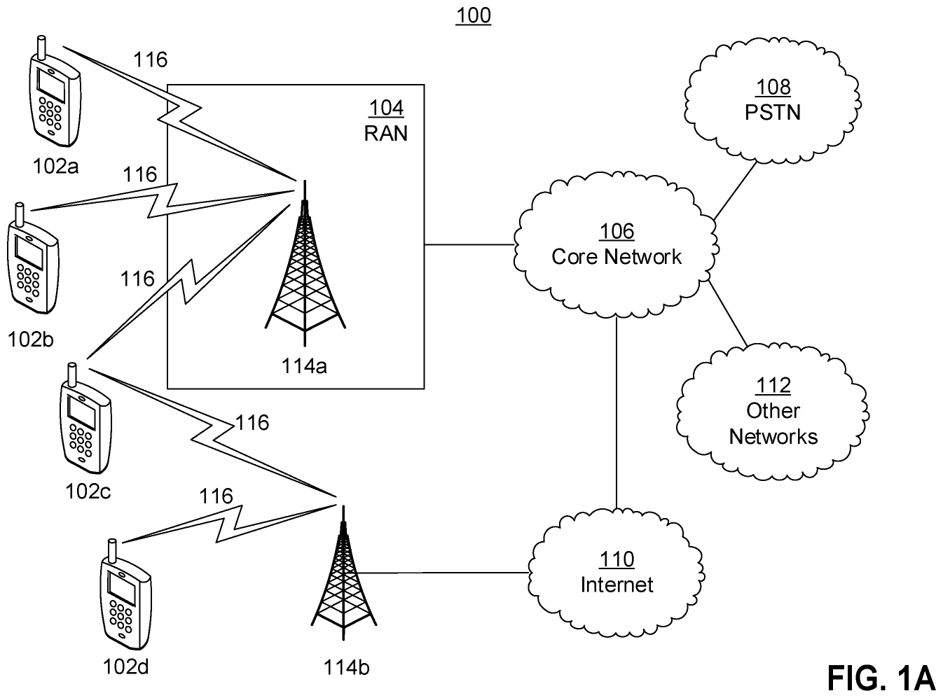

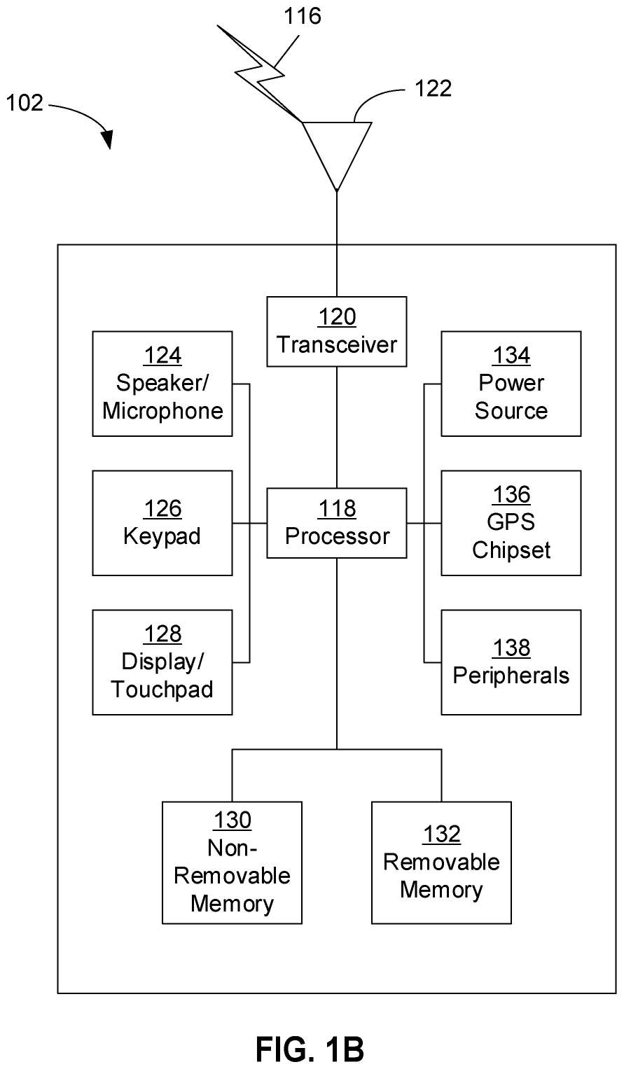

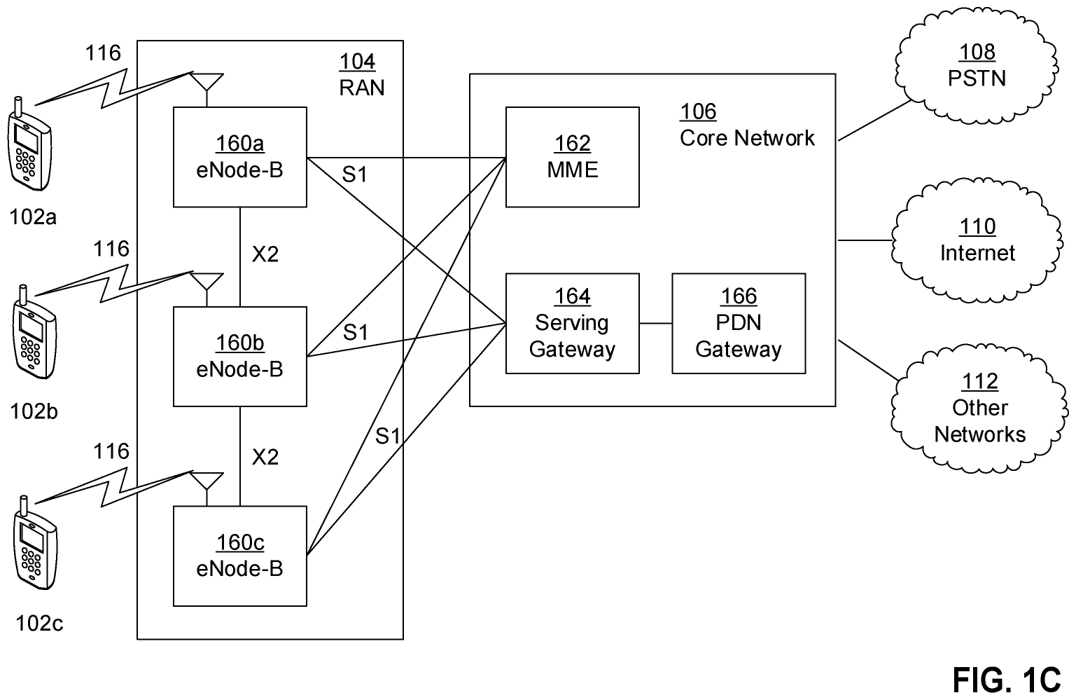

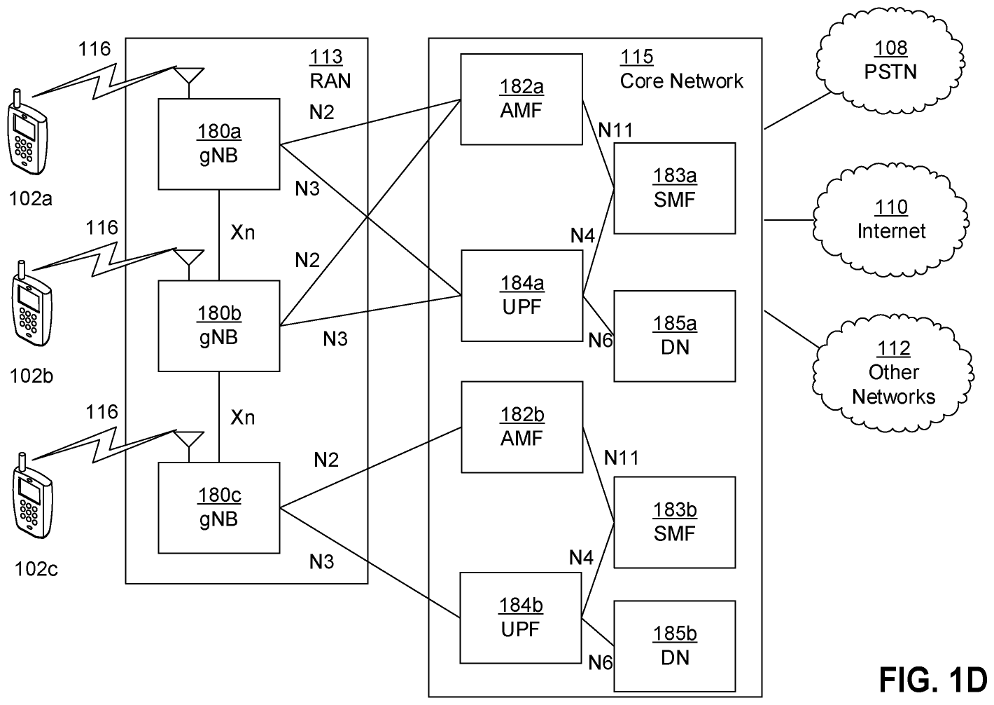

FIGS. 1A-1D generally show example networks for implementation. FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, UEs, terminals, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN. A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHZ channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As discussed, a WTRU that is in RRC_CONNECTED needs to continuously monitor the radio link for ensuring the link is good/reliable enough for communication, a RLM process. The WTRU monitors the DL quality based on the reference signal that is being broadcasted from the serving cell.

In case the WTRU is in operating in single connectivity, the WTRU will typically perform RLM on the PCell, and where the WTRU is operating in DC, the WTRU will typically perform RLM on both the PCell and the PSCell. The WTRU may configure which RLM-RS to monitor in order to determine the radio quality of the PCell and the PSCell (in case of DC). The network may also configure the WTRU to perform the RLM based on SSB, CSI-RS, or a combination of the two. WTRUs are configured with thresholds to determine whether the radio link being monitored is good/reliable enough, including Qout, which is the level at which the DL cannot be reliably received and shall correspond to out-of-sync block error rate (BLERout) that may be set at the 10% block error rate of a hypothetical PDCCH transmission, and Qin which is the level at which the DL may be significantly more reliably received than at Qout and shall correspond to in-sync block error rate (BLERin) that may be set at the 2% block error rate of a hypothetical PDCCH transmission.

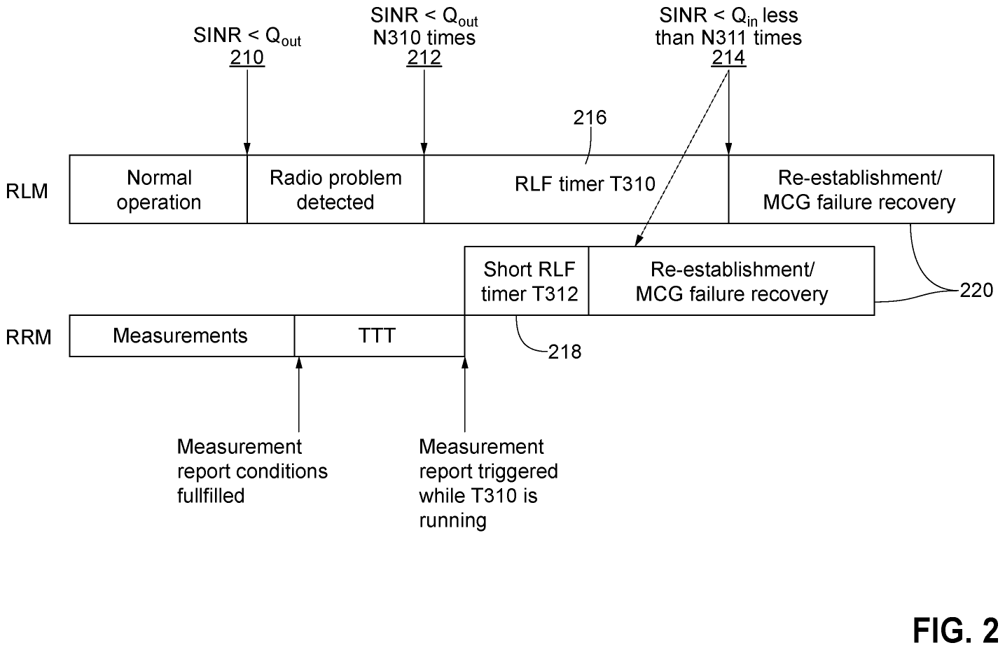

The WTRU may also be configured with timers and counters that are used to determine the reliability of the link being monitored. FIG. 2 illustrates the RLM and RLF detection mechanisms and various timers. The link monitoring may begin (210) when the signal to noise and interference ration (SINR) is less than Qout. The counter N310 (212) is the number of consecutive times that an out of sync indication may be received at the RRC from the lower layers (e.g., PHY) before RRC starts considering the link being monitored as experiencing reliability problem. The counter N311 (214) is the number of consecutive times that an in-sync indication may be received at the RRC from the lower layers (e.g., PHY) before RRC considers the link being monitored has become reliable again. RLF time T310 (216) is the duration of the timer that may be started upon N310 consecutive out-of-sync indications received from lowers, and stopped upon N311 consecutive in-sync indications.

As also shown in FIG. 2, if the T310 timer expires before the reception of N311 consecutive in-sync indications from lower layers, RRC may consider the link as failed and declare an RLF (Radio Link Failure). The WTRU may employ another timer T312 (218) to detect RLF, which may be associated with measurement reporting. A measurement reporting configuration may be associated with timer T312 (218). When the reporting conditions are fulfilled and a measurement report may be to be sent, and if this measurement reporting configuration has been associated with T312, the WTRU will check if the T310 (216) is already running (i.e., RLM has already identified a problem and waiting for the recovery). If so, the WTRU starts the T312 timer (218), with the duration set to the configured T312. If the problem is not resolved before the timer expires, then the WTRU may declare an RLF (220). Basically, T312 may be used to detect a late holdover (HO), i.e., had the measurement reporting been sent earlier than the radio link problem started, the WTRU would probably been handed over to a target cell in time.

In various circumstances, the RRC may be considered an RLF, such as, one or more of the following: (1) upon random access problem indication from MAC (e.g., when a WTRU does not receive a random-access response (RAR) after sending a random-access preamble to the network a certain number of times); (2) upon indication from RLC that the maximum number of retransmissions has been reached; (3) if connected as an Integrated Access Backhaul (IAB)-node, upon Back Haul (BH) RLF indication received on BackHaul Adaptation Protocol (BAP) entity (i.e., the link between the IAB node and the network has failed); or (4) upon consistent uplink LBT (listen before talk) failure indication from MAC when operating in unlicensed mode.

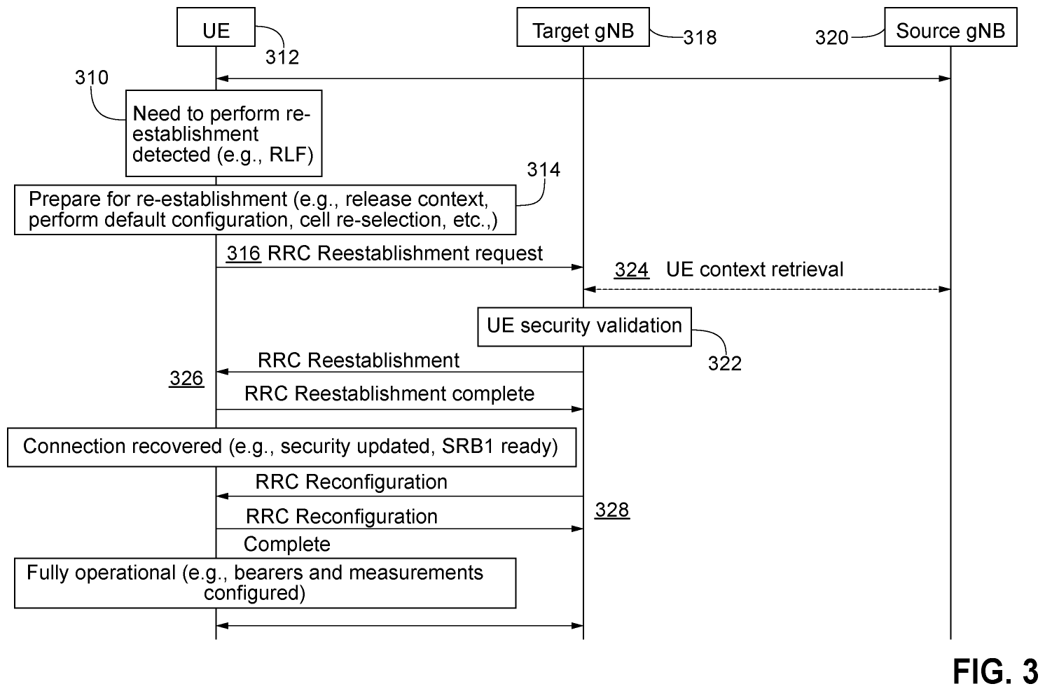

A high-level overview of the re-establishment procedure is depicted in FIG. 3. Upon detecting an RLF (310) according to any of the causes described above, the WTRU (UE 312) performs an RRC re-establishment to recover the radio link. In addition to RLF, there are also several triggers for the WTRU to trigger re-establishment (314), such as, one or more of: (1) upon re-configuration with sync failure with the target cell during HO; (2) Upon HO failure from NR to another RAT; (3) Upon integrity check failure for CP data (e.g., data received via SRB1 or SRB2); or (4) upon RRC connection reconfiguration failure (e.g., WTRU unable to compile/execute the received RRC reconfiguration file).

During the re-establishment procedure, the WTRU may perform several functions, such as reset of the MAC; release the WTRU configuration/context (including security configuration); perform cell re-selection (i.e., select the cell with the best radio quality the WTRU can measure at the time); or apply default configurations and send an RRC Re-establishment request message (316) to the network (Target gNB, 318). A WTRU security validation (322) may be performed based on messages (324) between the Target gNB (318) and the Source gNB (320). The message (324) may include information such as the identity of the WTRU (e.g., C-RNTI) at the source cell where the re-establishment was triggered, the PCI of the source cell, security integrity information that may be derived based on the security configuration that was used at the source cell, the cause of the re-establishment (e.g., RLF, integrity verification failure, reconfiguration failure, etc.,).

The network (Source gNB; 320) will use the security validation (322) included in the re-establishment request (326) to verify the request is from a legitimate WTRU and recover the latest WTRU context/configuration using the provided WTRU identity and source cell identity (e.g., if the WTRU is re-establishing at a target cell different from the source cell and the target cell is served by a gNB that may be different from the gNB serving the source cell, the target gNB may request the WTRU context/configuration information from the source). The network may send the WTRU an RRC Re-establishment message, which includes information for the WTRU to update the security context. The Signaling Radio Bearers are used for the transmission of RRC and NAS messages. SRB1 may be now up and running and the network can send an RRC Reconfiguration message (328) to the WTRU to finalize the recovery (e.g., provide new WTRU identity, setup the bearers, configure measurements, etc.). The configuration of the WTRU identity, the bearers, measurements, etc., may be the same as that was used in the source cell before the re-establishment was triggered or it may be different (e.g., another WTRU at the target may already be using the identity, not all the bearers may be admitted at the target, some measurement configuration may have to be modified due to the target's capability/configuration, etc.).

In New Radio Release 16 (NR R16), the concept of conditional reconfiguration was introduced, where the WTRU may be provided with an RRC reconfiguration (e.g., a HO command) that may be executed when certain measurement conditions are fulfilled (e.g., neighbor cell becomes better than the serving cell by more than a certain threshold). That is, instead of the legacy way of the WTRU sending a measurement report and the network sending a HO command, the HO command may be already prepared and sent to the WTRU, and the WTRU will execute this already stored HO command when the measurement conditions are fulfilled. Conditional reconfiguration, as it is normally associated with HOs, may be referred to as CHO (Conditional HO). In order to ensure CHO works, network may ensure the target is already prepared (i.e., has been provided with the WTRU context/configuration, admitted the bearers, etc.). Also, it should be noted that the actual HO command (i.e., RRC reconfiguration message containing a reconfiguration with sync message) may be prepared by the target and just forwarded via the source to the WTRU.

If the WTRU is configured with conditional reconfiguration, the WTRU performs a slightly enhanced re-establishment procedure. The WTRU may not release its context/configuration at the start of the re-establishment procedure but may determine if the cell re-selection procedure results in a selecting a cell that is a CHO target (i.e., WTRU already has a CHO stored for that target and target is already prepared for the WTRU). If so, there may be no need to continue with the re-establishment procedure and the WTRU just executes the associated CHO command.

It is possible that the re-establishment procedure may not succeed due to several reasons. Potential examples include the WTRU was not able to perform cell re-selection within a given time (e.g., timer T311, which may be started when the WTRU starts the cell re-selection procedure, expires before the WTRU has found a suitable cell to re-establish to); the WTRU was able to find a suitable cell but the cell became not suitable anymore before the re-establishment procedure may be completed; or the WTRU did not receive the Reestablishment message from the network within a given time after sending the re-establishment request (e.g. timer T301, which may be started when the WTRU sends the re-establishment request, expires before the reception of the reestablishment command from the network).

In these cases, the WTRU may be forced to go to RRC_IDLE mode and a recovery via connection setup from scratch may be triggered by the WTRU, which may be a more lengthy procedure than the re-establishment, as there may be no RAN level context fetching and the CN may have to be involved in setting up/configuring the bearers. A similar recovery from scratch may be performed (this time triggered by the network), if the WTRU context was not retrieved properly upon the reception of the re-establishment request.

As discussed herein, the WTRU may be configured with several timer values and counters/constants that are used in the detection of and recovery from radio link problems. The WTRU may be provided with the timer and counters configuration either in a dedicated (i.e., WTRU specific) or broadcasted manner (i.e., cell specific). The Information Element (IE) RLF-TimersAndConstants may be used to configure WTRU specific timers and constants, and may be included in the main serving cell configuration for the PCell, and if the WTRU is operating in DC, also for the PSCell.

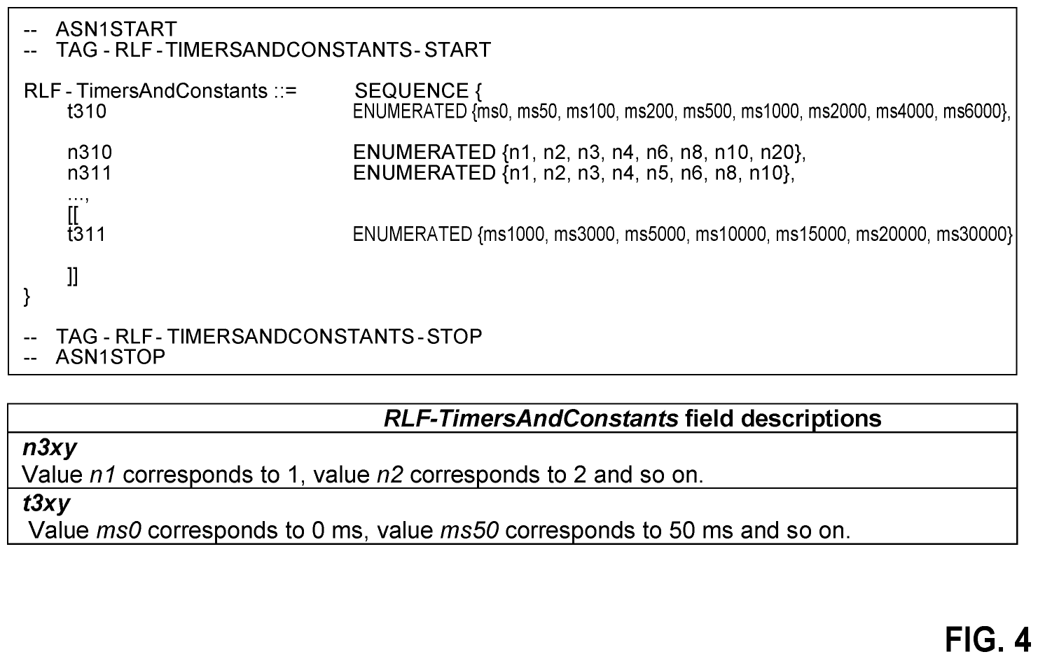

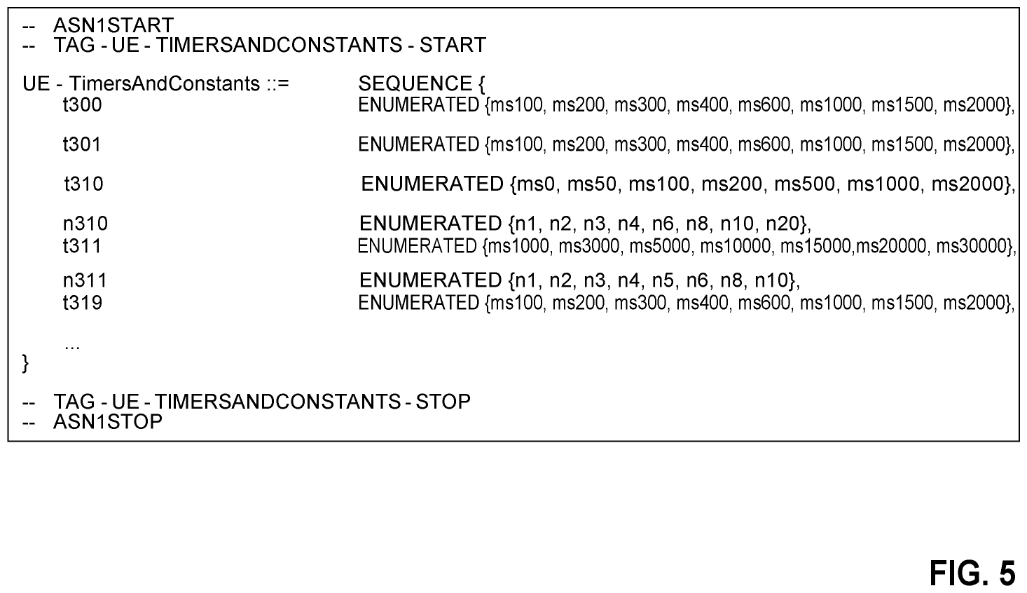

An example of the information element and the field descriptions for RLF timers and constants is shown in FIG. 4. The IE timers and constants included in SIB1 may be used by the WTRU in RRC_CONNECTED, RRC_INACTIVE and RRC_IDLE (which contains additional timers that may be used for other purposes). As exemplified in FIG. 5, if the WTRU is provide with the RLF timers and constants (and/or RLF thresholds), the timers/counters (and thresholds) configured therein will override the ones that are broadcasted in SIB1 in the UE-TimersAndConstants.

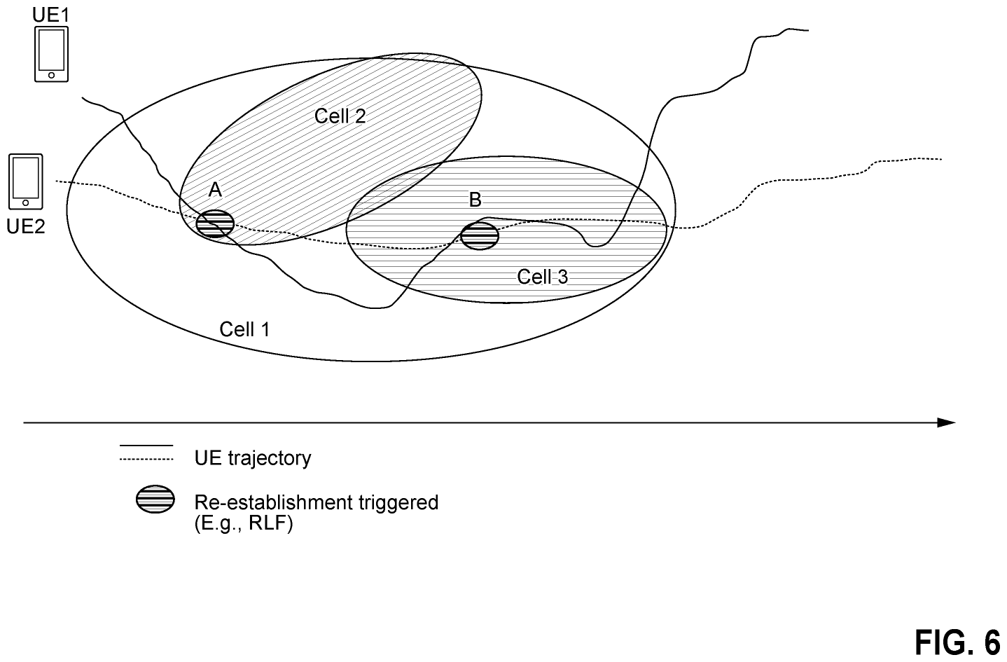

FIG. 6 illustrates an example of the problem of handling of RLFs. From an operational simplicity point of view, the easiest way for the network to operate will be to configure the timers and constants related to RLF for all the WTRUs via SIB1 broadcast. However, different WTRUs (e.g., UE1 and UE2 in FIG. 6) may have different characteristics. For example, they may be traveling at different speeds, have different bearer configurations, etc. In addition, the network may decide to configure the timer and counter values that are compatible with the WTRU characteristics. However, the WTRU bearer configuration changes from time to time. Not only that, but the activity level of the bearers may also not be constant (e.g., intermittent behavior where a burst of heavy traffic may be followed by long periods of inactivity).

Considering the scenario discussed above and illustrated in FIG. 6, both WTRUs (UE1 and UE2) may experience the triggering conditions for re-establishment at locations A and B (e.g., RLF). At point A, one WTRU (UE1) may have a very active bearer that has very low latency requirements, while another WTRU (UE2) may not have such a bearer (or may have a bearer that has similar requirements but may not be active). Both WTRUs, under legacy RLF handling, will trigger re-establishment, and may become connected to cell 2 and soon handed over back to cell 1 (as may be seen from the trajectory of the WTRUs). For one WTRU (UE1), that has an active bearer that may be delay sensitive, this probably may be the best action to be taken. However, for the other WTRU (UE2), the re-establishment to cell 2 and then HO back to cell1 may have been unnecessary, as the performance of the WTRUs bearers would not have been impacted if the WTRU did nothing until it has gone back into proper coverage of cell1. The situation may be the reverse in location B, there the activity level of the one WTRU's (UE1) bearer has dropped while the activity level of the other WTRU's (UE2) bearer has increased.

It may be impractical, if not impossible, for the network to keep track of the varying conditions of the WTRU bearer configuration, activity level, mobility state, trajectory, etc., and configure the timers and counters that control the RLF detection and RLF recovery procedures. In the embodiments discussed herein, the WTRU may be configured to modify the detection of the RLF based on current WTRU bearer configuration, etc.

In embodiments, the WTRU may be configured to use different n310/n311/t310/t312 value sets, depending on the type of bearer that it may be configured with. For example, the WTRU may use value set 1 if the WTRU has bearers have a QoS level of x or less (e.g., in terms of delay tolerance), use value of set 2 if the WTRU has bearers that have QoS levels between x and y, use value set 3 if the WTRU has bearers that have QoS levels equal to or greater than y, etc.; may use value set 1 if all the bearers have a QoS level of x or less, otherwise use value set 2; may use the value set that may be associated with the bearer that has a QoS level that is most strict; may use the value set that is associated with the bearer that has a QoS level that is least strict; or may use the value set that is the average of the bearer that has a QoS level that is most strict and that is least strict.

The term QoS level refers to one or more parameters that are used to define the Quality of Service (QOS) of a bearer. For example, the QoS level may be the latency tolerance of a bearer, the minimum bit rate requirements, the reliability (e.g., block error rate), priority level, etc., or a combination of all these.

In embodiments, the WTRU may be configured with only one baseline set of n310/n311/t310/t312 values and update/scale these values depending on the type of configuration of the bearer. For example: the WTRU may be configured to use the baseline values if the WTRU has bearers have a QoS level of x or less, scale the values by a factor of n1 if the WTRU has bearers that have QoS levels between x and y, scale the values by a factor of n2 if the WTRU has bearers that have QoS levels above y, etc., In this example, n1 and n2 may be the same for each parameter (i.e. applicable to all n310/n311/t310/t312) or there may be a different scaling value associated with each parameter.

In embodiments, the WTRU may be configured with only one set of n310/n311/t310/t312 values and update these values by adding/subtracting a delta value depending on the configuration of the bearer. For example, the WTRU may be configured to use the baseline values if the WTRU has bearers have a QoS level of x or less, add a delta value of c1 for the counters and t1 for the timers if the WTRU has bearers that have QoS levels between x and y, add a delta value of c2 for the counters and t2 for the timers if the WTRU has bearers that have QoS levels above y, etc.,. In this example, c1 and c2 may be the same for each counter (i.e., applicable to both n310 and n311) or there may be a different delta value associated with each counter. Similarly, t1 and t2 may be the same for each timer value (i.e., applicable to both t310 and t312) or there may be a different delta value associated with each timer.

In embodiments, the WTRU may be configured with a new timer T3xx (e.g., with an associated timer value t3xx), and the WTRU starts this timer after T310 or T312 has expired (the same value or a separate value may be specified corresponding to T310 and T312) and declare RLF only when T3xx expires. The timer value may be configured to be dependent on the configuration of the bearers for the WTRU. For example, if t3xx set to 0 if the WTRU only has bearers with QoS levels of x or less; if t3xx set to t1 if the WTRU has at least one bearer with QoS level between x and y; or if t3xx set to t2 if the WTRU has at least one bearer with QoS level greater than y, etc.

A baseline t3xx value(s) may be configured and the WTRU may scale it up/down or apply a delta value on the baseline value(s) depending on the QoS of the bearers configured (as described for the other embodiments above).

In embodiments, the number of bearers may be considered in addition to the type of the bearers. For example, assume the WTRU has two bearers of QoS level y, and three bearers of QoS level z (z>y). Different value sets specified for two bearer types, and WTRU using a weighted average of the different values associated with each bearer (e.g., either linear averaging or based on a weighting factor associated with each group). If the WTRU is configured with the scaling factors of n1 and n2 for the bearers of type y and z, as discussed above, it may calculate the scaling factor to apply as a weighted average of n1 and n2 associated with the two types of bearers (e.g., n=(n1*2+n2*3)/5). Further, if the WTRU is configured with the T3xx timer configuration discussed above, it may calculate the timer value to apply as a weighted average of t1 and t2 associated with the two types of bearers (e.g. t3xx=(t1*2+t2*3)/5).

In embodiments, the WTRU may be configured to modify the detection of the RLF based on current total WTRU data or activity level and defer RLF detection based on current WTRU data activity.

As an example, the WTRU may be configured to use different n310/n311/t310/t312 value sets, depending on the current total UL buffer level of all bearers. For example, the WTRU may be configured to use value set 1 if the total UL buffer level may be xMB or less, use value of set 2 if the buffer level may be between x MBs and y MBs, use value set 3 if the buffer level may be equal to or greater than y MBs, etc.,

In embodiments, the WTRU may be configured with only one baseline set of n310/n311/t310/t312 values and update/scale these values depending on the current total UL buffer level of all bearers. For example, the WTRU may be configured to use the baseline values if the total UL buffer level of all bearers may be x MB or less, scale the values by a factor of n1 if the buffer level may be between x MB and y MB, scale the values by a factor of n2 if the buffer level may be above y MBs, etc., In another example, the WTRU may be configured to use the baseline values if the buffer level may be x MB or less and scale the values by a factor of n1*(current buffer level/x) for buffer level greater than x. In these examples, n1 and n2 may be the same for each parameter (i.e., applicable to all n310/n311/t310/t312) or there may be a different scaling value associated with each parameter.

In embodiments, the WTRU may be configured with only one baseline set of n310/n311/t310/t312 values and update these values by adding/subtracting a delta value depending on the current total UL buffer level. For example, the WTRU may be configured to use the baseline values if the total UL buffer level may be x MBs or less, add a delta value of c1 for the counters and t1 for the timers if the buffer level may be between x MBs and y MBs, add a delta value of c2 for the counters and t2 for the timers if the buffer level may be above y MBs, etc., In this example, c1 and c2 may be the same for each counter (i.e., applicable to both n310 and n311) or there may be a different delta value associated with each counter. Similarly, t1 and t2 may be the same for each timer value (i.e., applicable to both t310 and t312) or there may be a different delta value associated with each timer. In another example, the WTRU may be configured to use the baseline values if the buffer level may be x MBs or less and for buffer levels above x, update the values by adding c*(current buffer level/x) for the counters and t*(current buffer level/x) for the timers. In this example, c may be the same or different for each counter. Similarly, t may be the same or different for each timer.

In embodiments, the WTRU may be configured with a new timer T3xx (e.g., with an associated timer value t3xx), and the WTRU starts this timer after T310 or T312 has expired (the same value or a separate value may be specified corresponding to T310 and T312) and declare RLF only when T3xx expires. The timer value may be configured to be dependent on the total UL buffer level. For example, t3xx may be set to 0 if the total UL buffer level is less than x MBs; t3xx may be set to t1 if the total UL buffer level is between x and y MBs; and t3xx may be set to t2 if the total UL buffer level is more than y MBs, etc.

A baseline t3xx value(s) may be configure and the WTRU may scale it up/down or apply a delta value on the baseline value(s) depending on the total UL buffer level (as described for the other embodiments above).

Variants of all the above embodiments may be envisioned where instead of (or in addition to) the total UL buffer level, total data rate of the bearers are considered. The data rate may be only for the UL, only for the DL, or a combination of the two (e.g., the maximum, minimum, weighted average, sum, etc.). For example, the WTRU may be configured to use different n310/n311/t310/t312 value sets, depending on the current total data rate. For example, the WTRU may be configured to use value set 1 if the total data rate is x Mbps or less, use value of set 2 if the data rate is between x Mbps and y Mbps, use value set 3 if the buffer level is equal to or greater than y Mbps, etc. Further, the WTRU may be configured with one baseline set of n310/n311/t310/t312 values and update/scale these values depending on the current total data rate. For example, the WTRU may be configured to use the baseline values if the total data rate is x Mbps or less, scale the values by a factor of n1 if the data rate is between x Mbps and y Mbps, scale the values by a factor of n2 if the data rate is above y Mbps, etc., In this example, the WTRU may be configured to use the baseline values if the total data rate is x Mbps or less and for data rates above x, scale the values by a factor of n1*(current data rate/x) for data rates than x Mbps, and so on.

Variants of all the above embodiments may be envisioned where instead of (or in addition to) the buffer level and data rates, the activity/inactivity level of the bearers are considered. The inactivity level may be considered in the UL, DL, or a combination (e.g., consider the minimum of the UL and DL inactivity to be the inactivity time, consider the average of the UL and DL inactivity to be the inactivity timer, etc.,). For example, the WTRU may be configured to use different n310/n311/t310/t312 value sets, depending on the inactivity time. For example, the WTRU may be configured to use value set 1 if it had an activity not more than x ms ago, use value of set 2 if there was no activity between xms and y ms, use value set 3 if there was no activity for y ms or more, etc. Further, the WTRU may be configured with one baseline set of n310/n311/n310/n312 values and update/scale these values depending on the current total data rate. In this example, the WTRU may be configured to use the baseline values if it had inactivity not more than x ms ago and scale the values by a factor of n1 if there was no activity between x ms and y ms, scale the values by a factor of n2 if there was no activity for more than y ms, etc., In another example, the WTRU may be configured to scale the values by a factor of n1*(current inactivity timer/x) for inactivity levels more than x ms, and so on.

In the above, the activity may refer to only user plane data, only to control plane data or to both (e.g., if only user plane data is considered, WTRU may not consider RRC messages/responses, ACK/NACKs for DL/UL data, MAC/RLC/PDCP control PDUs from the WTRU/gNB, etc., in determining the inactivity level)

Variants of all the above embodiments may be envisioned where only a subset of the bearers are considered in calculating the buffer level, data rate, or inactivity level. The subset of bearers to be considered may be indicated to the WTRU explicitly (e.g., bearer IDs) or by category (e.g., the WTRU configured to consider only bearers of a certain QoS level/category, WTRU configured to not consider bearers of a certain QoS level/category, etc.).

In embodiments, the WTRU may be configured to modify the detection of the RLF based on current mobility level/state, so as to defer RLF detection based on current WTRU mobility level. For example, the WTRU may be configured to use different n310/n311/t310/t312 value sets, depending on its current mobility state. In this example, the WTRU may be configured to use value set 1 if the WTRU is stationary, use value of set 2 if the WTRU is moving between x m/s and y m/s, use value set 3 if the WTRU is moving at more than z m/s, etc.

In embodiments, the WTRU may be configured with only one baseline set of n310/n311/t310/t312 values and update/scale these values depending on its current mobility state. For example, the WTRU may be configured to use the baseline values for speeds less than x m/s, scale the values by a factor of n1 if the speed may be between x m/s and y m/s, scale the values by a factor of n2 if the speed may be above y m/s, etc., In another example, the WTRU may be configured to use the baseline values if the speed may be x m/s or less and scale the values by a factor of n1*(x/current speed) for speeds greater than x. In these examples, n1 and n2 may be the same for each parameter (i.e., applicable to all n310/n311/t310/t312) or there may be a different scaling value associated with each parameter.

In embodiments, the WTRU may be configured with only one baseline set of n310/n311/t310/t312 values and update these values by adding/subtracting a delta value depending on its current mobility state. For example, the WTRU may be configured to use the baseline values if its speed may be less than x m/s, add a delta value of c1 for the counters and t1 for the timers if its speed may be between x m/s and y m/s, add a delta value of c2 for the counters and t2 for the timers if the speed may be above y m/s, etc., In this example, c1 and c2 may be the same for each counter (i.e., applicable to both n310 and n311) or there may be a different delta value associated with each counter. Similarly, t1 and t2 may be the same for each timer value (i.e., applicable to both t310 and t312) or there may be a different delta value associated with each timer. In another example, the WTRU may be configured to use the baseline values if its speed may be x m/s or less and update the values by adding c*(x/current speed) for the counters and t*(x/current speed) for the timers. In this example, c may be the same or different for each counter. Similarly, t may be the same or different for each timer.

In embodiments, the WTRU may be configured with a new timer T3xx (e.g., with an associated timer value t3xx), and the WTRU starts this timer after T310 or T312 has expired (the same value or a separate value may be specified corresponding to T310 and T312) and declare RLF only when T3xx expires. The timer value may be configured to be dependent on the WTRUs mobility state. For example, t3xx may be set to 0 if the WTRU speed is more than y m/s; t3xx may be set to t1 if the WTRU speed is between x and y m/s; and t3xx set to t2 if the WTRU speed is less than x m/s, etc.

A baseline t3xx value(s) may be configure and the WTRU may scale it up/down or apply a delta value on the baseline value(s) depending on its current speed (as described for the other embodiments above).

In embodiments, the WTRU may be configured to modify the detection of the RLF based on its current location and to defer RLF detection based thereon. As an example, the WTRU may be configured to use different n310/n311/t310/t312 value sets, depending on its current location. For example, the WTRU may be configured to use value set 1 if the WTRU is located between GNSS coordinates x and y, use value of set 2 if the WTRU is located between coordinates y and z, etc.

In embodiments, the WTRU may be configured with a new timer T3xx (e.g., with an associated timer value t3xx), and the WTRU starts this timer after T310 or T312 has expired (the same value or a separate value may be specified corresponding to T310 and T312) and declare RLF only when T3xx expires. The timer value may be configured to be dependent on the WTRUs current location. For example, t3xx may be set to 0 if the WTRU is located within GNSS coordinates a and b; t3xx may be set to t1 if the WTRU is located within GNSS coordinates b and c; and t3xx set to t2 if the WTRU is located within GNSS coordinates c and d, etc.

In embodiments, the WTRU may be configured to modify the detection of the RLF based on its current serving cell and/or neighbor cells and defer RLF Detection based thereon. For example, the WTRU may be configured to use different n310/n311/t310/t312 value sets, depending on its current serving cell identity (e.g. PCI). In this example, the WTRU may be configured to use value set 1 if the WTRU is being served by cell ID1, use value set 2 if the WTRU being served by cell ID 2, etc.

In embodiments, in addition to or instead of the cell identity, the configuration may be based on frequency; for example, the value set 1 for any serving cell with freq 1, the value set 2 for any serving cell with freq 2, and the value set 1a for serving cell with cell id 1 and freq a, value set 1b for serving cell with cell id 1 and freq b, etc.

In embodiments, the WTRU may be configured to use different n310/n311/t310/t312 value sets, depending on the neighbor cell(s) it may detect; for example, the WTRU may be configured to use value set 1 if it may detect neighbor cells within a neighbor cell ID list 1, use value set 2 if it being served by neighbor cells within a neighbor cell ID list 2, etc.,. Further criteria may be configured with regard to the neighbor cell to apply the corresponding value set. In this example, one or more may apply: (1) all the cells within the neighbor cell list has to be detected; (2) at least one of the cells within the neighbor list has to be detected; (3) at least a certain number or percentage of the neighbor list has to be detected; and so on.

In embodiments, in addition to or instead of the cell identity, the configuration may be based on frequency of the neighbor cells; for example, value set 1 for neighbor cells with freq 1, value set 2 for any serving cell with freq 2.

In embodiments, a signal level threshold may be specified along with the serving cell and neighbor cell based configurations above; for example, the WTRU may apply different value sets for different signal level ranges of the serving cell with the specified identity (if no specific cell ID may be specified, the WTRU may apply similar behavior to all serving cells based on the signal level only, i.e., similar behavior regardless of which particular cell the WTRU is being served at). The WTRU may apply different value sets for different signal level ranges of the neighbor cells within the specified neighbor cell list (E.g., for a given list of neighbor cell, there may be different associated value sets corresponding with different minimum signal levels of the neighbor cells). Further, the WTRU may apply different value sets depending on the comparison of the signal levels of a neighbor cell (or list of neighbor cells) and the serving cell, etc.

In embodiments, the WTRU may be configured with a new timer T3xx (e.g., with an associated timer value t3xx), and the WTRU starts this timer after T310 or T312 has expired (the same value or a separate value may be specified corresponding to T310 and T312) and declare RLF only when T3xx expires. The timer value may be configured to be dependent on the WTRUs current serving cell. For example, t3xx may be set to 0 if the WTRU is being served by cells with IDs in cell ID list 1; and t3xx may be set to t1 if the WTRU is being served by cells with IDs in cell ID list 2, etc.

In embodiments, the WTRU may be configured with a new timer T3xx (e.g., with an associated timer value t3xx), and the WTRU starts this timer after T310 or T312 has expired (the same value or a separate value may be specified corresponding to T310 and T312) and declare RLF only when T3xx expires. The timer value may be configured to be dependent on the WTRUs current neighbor cell(s). For example, t3xx may be set to 0 if the WTRU detects neighbor cells with IDs in neighbor cell ID list 1; and t3xx may be set to t1 if the WTRU detects neighbor cells with IDs in neighbor cell ID list 2, etc.

Embodiments may be envisioned where the T3xx values may also be dependent on the signal level of the serving cell, the neighbor cells, or a comparison between them, as described above for the configuration that may be based on multiple value sets. Other embodiments may be envisioned where the T3xx values may be configured based on the frequency of the serving or neighbor cells, in addition or instead of the cell IDs.

In embodiments, the WTRU may be configured to modify the detection of the RLF based on the current time (of day) and defer RLF detection based thereon. For example, the WTRU may be configured to use different n310/n311/t310/t312 value sets, depending on the current time. In this example, the WTRU may be configured to use value set 1 if the time of the day is between t1 and t2 (where t1 and t2 are specified, for example, as HH:MM:SS:mmm, i.e., hours, minutes, seconds, milliseconds), within another set 2 for times between t2 and t3, and so on.

In embodiments, the WTRU may be configured with a new timer T3xx (e.g., with an associated timer value t3xx), and the WTRU starts this timer after T310 or T312 has expired (the same value or a separate value may be specified corresponding to T310 and T312) and declare RLF only when T3xx expires. The timer value may be configured to be dependent on the current time. For example, t3xx may be set to 0 if the current time is between t1 and t2; t3xx may be set to ta if the current time is between t2 and t3; and t3xx may be set to tb if the current time is between t3 and t4, etc.

In embodiments, the WTRU may be configured with different sets of values (or different t3xx timers) that correspond to different days. For example, different set of values may be configured for weekends (or holidays) as compared to weekdays.

In embodiments, the WTRU may be configured to consider and/or defer RLF based on predicted data activity level (buffer size, data rate, data inactivity, etc.,) instead of (or in addition to) to the current data activity level, to determine on how to modify the RLF detection. For example, the WTRU may be configured with different value sets or scaling factors or delta values that are corresponding to the current data activity and the predicted activity level (E.g. if the current UL buffer size may be less than x MBs and the predicted buffer size may be not going to be more than y MBs for a certain duration, e.g. t1 ms, use value set 1, if the current buffer size may be less than x MBs and the predicted buffer size may be going to be between y and z MBs for a certain duration, e.g. t1 ms, use value set 2, etc.). Separately or in addition, the WTRU may be configured with a weighting factor to apply to the current values and predicted values (e.g., if the current buffer value may be y MBs and scaling factor of n1 was associated for that buffer level, and the predicted buffer value may be z MBs and scaling factor of n2 was associated with it, the WTRU may calculate the scaling factor as (1−a)*n1+a*n2, where a may be the scaling factor configured for the predicated values.

In embodiments, the WTRU may be configured to consider and/or defer RLF based on predicted mobility level instead of (or in addition to) to the current mobility level, to determine on how to modify the RLF detection. For example, the WTRU may be configured with different value sets or scaling factors or delta values that correspond to the current and the predicted mobility levels (E.g. if the current speed may be less than x m/s and the predicted speed may be not going to be more than y m/s for a certain duration, e.g. t1 ms, use value set 1, if the current speed may be less than x m/s and the predicted speed may be between y and z m/s for a certain duration, e.g. t1 ms, use value set 2, etc.). Separately or in addition, the WTRU may be configured with a weighting factor to apply to the current values and predicted values (e.g., if the current speed may be y m/s and scaling factor of n1 was associated with that speed, and the predicted speed may be z m/s and scaling factor of n2 was associated with it, the WTRU may calculate the scaling factor as (1−a)*n1+a*n2, where a may be the scaling factor configured for the predicated values.

A combination of any of the above embodiments may be envisioned. For example, the WTRU may be configured to apply one set of values (or scaling factors or delta values) for certain time durations at certain locations (e.g. value set 1_l1_t1 to be applicable when the WTRU may be located in l1 when the current time may be t1, value set 1_l1_t2 to be applicable when the WTRU may be located in l1 when the current time may be within t2, etc.,). Further, the WTRU may be configured to apply one set of values (or scaling factors or delta values) for certain data activity at certain time durations (e.g., value set 1_d1_t1 to be applicable when the WTRUs UL data rate may be below d1 and the current time may be within t1, value set 1_d2_t1 to be applicable when the WTRUs UL data rate may be between d1 and d2 and the current time may be within t1, etc.,). The WTRU may also be configured to apply one set of values (or scaling factors or delta values) for certain data activity at certain time durations and mobility levels (e.g., value set 1_d1_t1_s1 to be applicable when the WTRUs UL data rate may be below d1, the current time may be within t1 and the WTRU may be moving at a speed of s1 or less; value set 1_d1_t1_s2 to be applicable when the WTRUs UL data rate may be below d1, the current time may be within t1, and the WTRU may be moving at a speed between s1 and s2, etc.,)

Application may be included that also take other WTRU and network conditions into consideration. Examples of WTRU and network conditions may include one or more of the following: the WTRU battery level (e.g., different sets of values for different battery level thresholds); the WTRU overheating level; the RAT of the serving cell; and the RAT of neighbor cells.

In embodiments, the WTRU may detect RLF like in legacy (i.e., use the legacy timers and constants), but refrain from doing the recovery (e.g., re-establishment) for a certain duration based on configurations that consider any or a combination of the parameters discussed herein for deferring the RLF detection. If the WTRU is not back in the coverage of the source cell where the RLF was detected after the configured duration has elapsed, the WTRU may start the recovery (e.g., start re-establishment procedure).

As noted herein, the duration to refrain from starting RLF recovery after RLF detection may be dependent on several parameters, such as one or more of: the type of bearers. For example, the WTRU may be configured to not delay the re-establishment if it has bearers with QoS level x, delay the re-establishment for t1 if it has only bearers with QoS levels between x and y, delay the re-establishment for t2 if it has only bearers with QoS levels between y and z, etc.; the WTRU data activity (e, g, the WTRU may be configured to delay the re-establishment for t1 if its UL data rate below x, delay the re-establishment for t2 if its UL data rate may be between x and y, and not delay the re-establishment if its UL data rate may be above y, etc., and—as in the case of deferred RLFs—the WTRU may also be configured to consider predicted WTRU data activity); the WTRU mobility level (e.g., the WTRU may be configured to delay the re-establishment for t1 if its speed may be below x, delay the re-establishment for t2 if its speed may be between x and y, etc. —again, as in the case of deferred RLFs—the WTRU may also be configured to consider predicted WTRU mobility level); the WTRU location (e.g., the WTRU may be configured to delay the re-establishment for t1 if the WTRU is located within location coordinates L0 and L1, delay the re-establishment for t2 if the WTRU is located within location coordinates L1 and L2, etc.); serving/neighbor cells (e.g., the WTRU may be configured to delay the re-establishment for t1 if the WTRU is being served by cells within cell ID list1, delay the re-establishment for t2 if the WTRU is being served by cells within cell ID list2, etc.); current time (e.g., the WTRU may be configured to delay the re-establishment for t1 if the current time may be between TO and T1, delay the re-establishment for t2 if the current time may be between T1 and T2, etc.); and any combination of all the above.

In embodiments, the WTRU may be configured to consider predicted trajectory and outage duration in addition or instead of the configured duration to delay the RLF recovery. For example, the WTRU may have an AI/ML model that has been trained to predict its trajectory, and estimate (e.g., from previous outages/RLFs at the current location), how long the outage will last (e.g., in terms of time duration or location coordinates for the coverage hole) and other channel conditions and conditions of the WTRU based on historical data for the channel conditions and/or the conditions of one or more WTRUs operating within the network. Based on the current mobility level, the trajectory and the current location, the WTRU may determine how long it will take (e.g., t2) before it will be back in the coverage of the source serving cell where the RLF was detected. If t2 is smaller than the configured duration to delay the RLF recovery, then the WTRU may delay the recovery by the specified duration (i.e., by the time the delay duration has elapsed, WTRU will most likely be back in the coverage of the source cell). However, if t2 is greater than the configured duration to delay the RLF, it means that even after delaying the recovery by the specified amount, the WTRU will not be back in the coverage of the serving cell and delaying the recovery would not have been the best decision. Thus, the WTRU may decide to perform the RLF recovery immediately (e.g., re-establish to another cell) for that case.

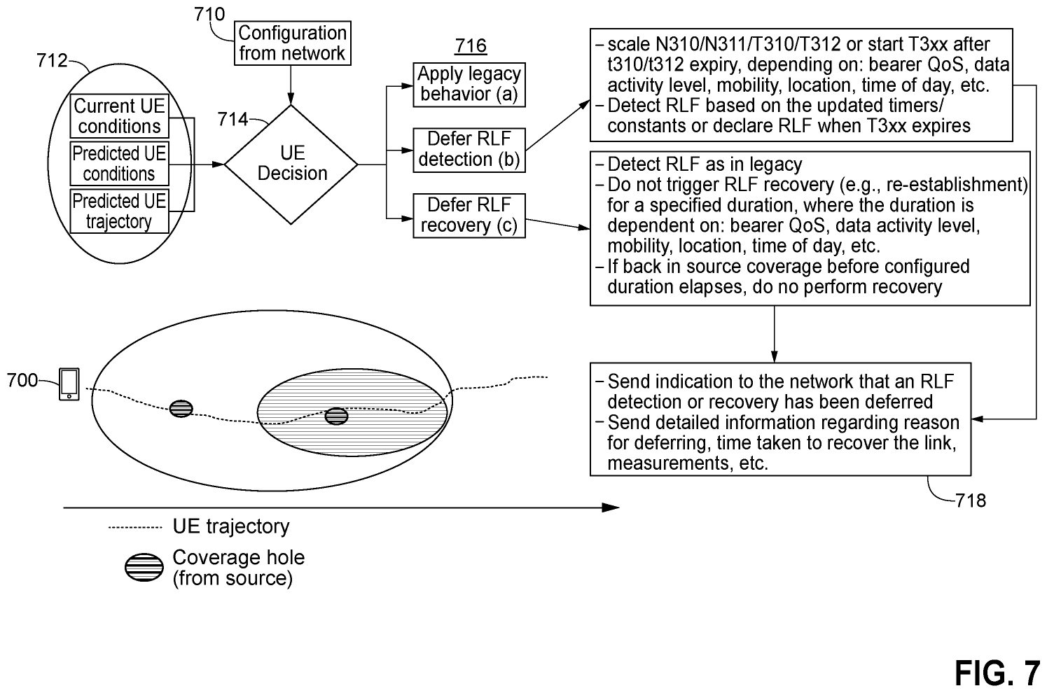

FIG. 7 shows an example implementation of various embodiments as discussed above. The WTRU 700 may determine, at 712, one or more WTRU conditions. The one or more WTRU conditions may include configured radio bearers, quality of service (QOS) settings of the configured radio bearers, a current data activity level of the configured radio bearers, a predicted data activity level of the configured radio bearers, a mobility state of the WTRU, a speed of the WTRU, a WTRU location, a predicted WTRU location, a WTRU trajectory, or a predicted WTRU trajectory. The WTRU 700 may be configured to receive configuration information 710. The configuration information 710 may include a plurality of RLF specific parameters. The plurality of RLF specific parameters may include an RLF counter, an RLF constant, an RLF timer, or an RLF threshold. The plurality of RLF specific parameters may be used to determine whether RLF has occurred. Generally, in addition to the configuration information (710) received by the WTRU (700) from the network, the current WTRU conditions and indications, the predicted WTRU conditions and the predicted WTRU trajectory (712) may be included in the decision process by the WTRU (714) to implement a particular RLF embodiment (716). Legacy behaviors (a) for the WTRU may be applied. The WTRU 700 may determine one or more channel conditions associated with RLM. For example, the WTRU 700 may predict one or more of the channel conditions and/or the conditions of the WTRU based on historical data related to one or more channel conditions and conditions of one or more WTRUs operating within the network. The WTRU 700 may detect (e.g., determine), at 714, an RLF specific parameter of the plurality of RLF specific parameters, for example, based on the one or more conditions of the WTRU. The WTRU 700 may determine, at 714, to defer RLF detection and/or defer RLF recovery. For example, the WTRU 700 may be configured to determine RLF detection and/or RLF recovery behavior based on the detected RLF specific parameters and/or the one or more channel conditions.

The WTRU 700 may determine to perform RLF recovery based on one or more of the one or more determined channel conditions associated with RLM, the one or more determined conditions of the WTRU, one or more predicted channel conditions, and/or one or more predicted conditions of the WTRU. Determining to perform RLF recovery may include determining whether to defer re-establishment of the radio link. The WTRU 700 may send an indication to the network based on determining the RLF detection and/or RLF recovery behavior.

As one possible alternative, a deferred RLF detection (b) may be implemented, based on updated timers/constants or the RLF may be declared at the expiration of the T3xx timer. Here, scale N310/N311/T310/Y312 or starting T3xx after t310/t312 expiry. The deferred RLF detection is preferably dependent on the bearer QoS, data activity level, mobility, location, time of day, etc. The WTRU defers detection of RLF based on the updated timers/constants or declare the RLF when T3xx expires. As another alternative, the RLF recovery (c) may be deferred. The deferred RLF detection may be applied as in (b) above or—as shown—detection of RLF based on legacy parameters (a). The RLF recovery may not be triggered dependent on a number of factors, such as bearer QoS, data activity level, mobility, location, time of day, etc. If the WTRU is back again in source coverage before the configurated duration elapses, recovery will not be performed. Depending on the decision made, an indication (718) may be sent to the network regarding the reason for the deferring, the time taken to recover the link, measurements, and other data. The WTRU 700 may send RLF information to the network. The RLF information may include a deferral cause, a time taken to recover the radio link (RL), one or more channel conditions at the time of RLF, one or more channel conditions at the time of RL recovery, a WTRU location at the time of the RLF, a WTRU location at the time of RL recovery, a time associated with RLF detection, and/or a time associated with RL recovery

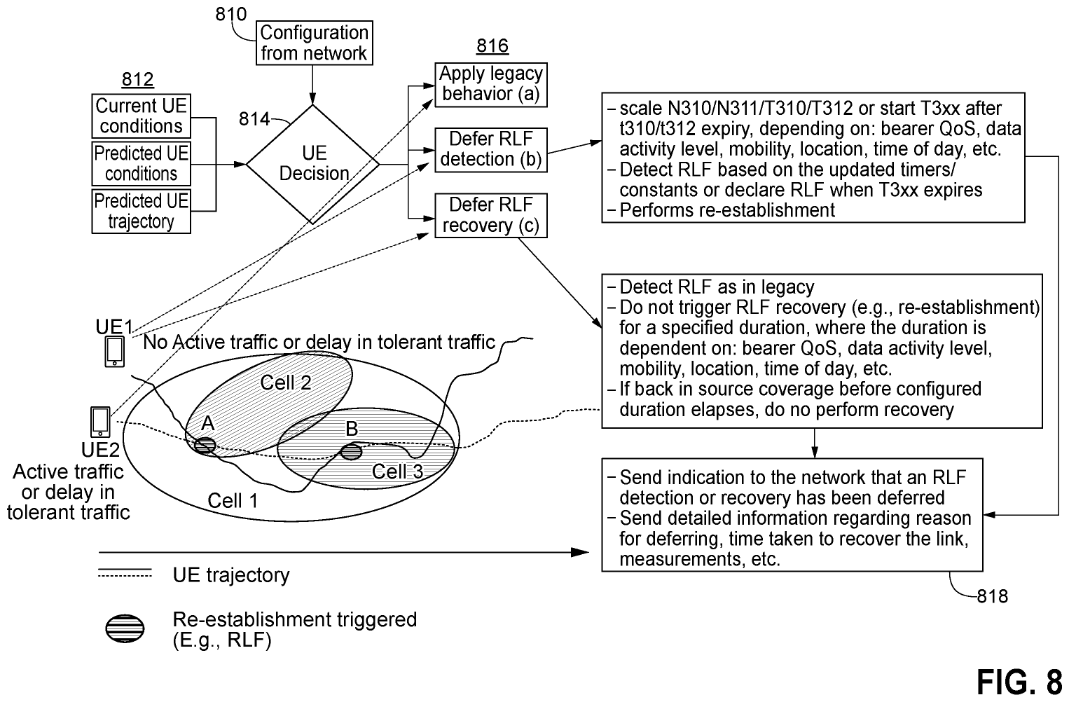

FIG. 8 shows an implementation as in FIG. 7 with the two WTRUS (UE1, UE2) as in FIG. 6. A first WTRU (UE1) may determine, at 812, one or more conditions of the first WTRU. A second WTRU (UE2) may determine, at 812, one or more conditions of the second WTRU. The one or more conditions (e.g., WTRU conditions) may include configured radio bearers, quality of service (QOS) settings of the configured radio bearers, a current data activity level of the configured radio bearers, a predicted data activity level of the configured radio bearers, a mobility state of the WTRU, a speed of the WTRU, a WTRU location, a predicted WTRU location, a WTRU trajectory, or a predicted WTRU trajectory. The first and second WTRUs may be configured to receive configuration information 810 from the network. The configuration information 810 may include a plurality of RLF specific parameters. The plurality of RLF specific parameters may include an RLF counter, an RLF constant, an RLF timer, or an RLF threshold. The plurality of RLF specific parameters may be used to determine whether RLF has occurred.

Generally, in addition to the configuration information (810) received by the WTRUs (UE1, UE2) from the network, the separate conditions and indications of the two different WTRU's (UE1, UE2), and, for example, the predicted WTRU conditions and the predicted WTRU trajectories (812) are included in the decision process by the WTRU (814). Depending on the WTRU, the particular RLF implementation (816) may be different. As shown, the second WTRU (e.g., UE2) may determine, at 814, to implement legacy behaviors (a). This decision, at 814, may be made based on the active traffic or delay in tolerant traffic as the second WTRU moves along its trajectory path. The first WTRU (e.g., UE1) may have no active traffic or delay tolerant traffic as the first WTRU moves along its trajectory path. The first WTRU (UE1) may determine, at 814, to implement a deferred RLF detection (b), based on updated timers/constants or the RLF may be declared at the expiration of the T3xx timer. Alternatively, the first WTRU (UE1) may determine, at 814, an RLF based on legacy parameters (a), while deferring RLF recovery dependent on one or more factors. Again, if the first WTRU (UE1) is back again in source coverage before the configurated duration elapses, recovery will not be performed. Further, depending on the decision made, an indication (818) may be made to the network regarding the reason for the deferring, the time taken to recover the link, measurements, and other data.

For example, the first WTRU may determine one or more channel conditions associated with RLM. For example, the WTRU may predict one or more of the channel conditions and/or the conditions of the WTRU based on historical data related to one or more channel conditions and conditions of one or more WTRUs (e.g., such as UE1 and UE2) operating within the network. The first WTRU may detect (e.g., determine), at 814, an RLF specific parameter of the plurality of RLF specific parameters, for example, based on the one or more conditions of the first WTRU. The first WTRU may determine, at 814, to defer RLF detection and/or defer RLF recovery. For example, the first WTRU may be configured to determine RLF detection and/or RLF recovery behavior based on the detected RLF specific parameters and/or the one or more channel conditions associated with the first WTRU. The first WTRU may determine to perform RLF recovery based on one or more of the one or more determined channel conditions associated with RLM, the one or more determined conditions of the WTRU, one or more predicted channel conditions, and/or one or more predicted conditions of the WTRU. Determining to perform RLF recovery may include determining whether to defer re-establishment of the radio link. The first WTRU may send an indication to the network based on determining the RLF detection and/or RLF recovery behavior.

In embodiments, the WTRU timers and constants that control the deferral of the RLF detection or/and RLF recovery are provided to the WTRU in several ways. Examples of ow they are provided to the WTRU, include one or more of: in a dedicated manner (e.g. RRC signaling, MAC signaling, etc.); a system information broadcast (e.g. SIB1); and the WTRU potential configurations and an indication sent to the WTRU (either via SIB or dedicated signaling) on which configuration to apply (e.g., an index to the configuration).

In embodiments, the network may send an indication to enable/disable the deferral of RLF detection or recovery (e.g. via SIB signaling, MAC CE, etc.). As an example, the network may send an indication to the WTRU whether to apply RLF detection deferral or RLF recovery deferral or both.

In embodiments, the WTRU may be configured to send an indication to the network regarding deferred RLFs. For example, if the WTRU was configured to defer the RLF by t1 ms as compared to legacy (based on any of the combination of embodiments described herein related to deferred RLF detection) and the radio link with the source was recovered at t2 ms (t2<t1), the WTRU may send an indication to the network (e.g. RRC message, MAC CE, etc.) that indicates that an RLF was deferred and the link was recovered in time. Additional information (E.g. measurement of serving and neighbor cells at the time of failure or/and the time of recovery, the time it took to recover the link, location information, etc.) may also be included in the indication. Or alternatively, the WTRU may just send an indication of a deferred RLF, and the network may later send a request for the details, such as the measurement reports and the time the WTRU was in failure (e.g., via WTRU information Response, on receiving the WTRU Information Request).

In embodiments, the WTRU may be configured to keep storing information about deferred RLFs and associated details like measurement reports and may provide them on request from the network (e.g., via WTRU information Request). Further, if the WTRU deferred the RLF and still the link was not recovered in time and RLF was declared, upon subsequent recovery (E.g., re-establishment), the WTRU may indicate to the network that an RLF report is available and that this RLF was a deferred RLF.

In embodiments, the WTRU may be configured to send an indication to the network regarding deferred RLF recovery. For example, if the WTRU was configured to defer the RLF recovery by t1 ms as compared to legacy (based on any of the combination of embodiments described herein related to deferred RLF handling) and the radio link with the source was recovered at t2 ms (t2<t1), the WTRU may send an indication to the network (e.g. RRC message, MAC CE, etc.) that indicates that an RLF recovery was deferred and the link was recovered in time. Additional information (E.g., measurement of serving and neighbor cells at the time of failure or/and the time of recovery, the time it took to recover the link, location information, etc.) may also be included in the indication. Or alternatively, the WTRU may just send an indication of a deferred RLF, and the network may later send a request for the details, such as the measurement reports and the time the WTRU was in failure (e.g., via WTRU Information Request).

In embodiments, the WTRU may be configured to keep storing deferred RLF recovery information and associated details like measurement reports and may provide them on request from the network (e.g., via WTRU information Response, on receiving the WTRU Information Request).

In embodiments, if the WTRU deferred the RLF recovery and still the link was not recovered in time and recovery was performed (e.g., re-establishment), the WTRU may indicate to the network that an RLF report is available and that this RLF was related to a deferred RLF recovery.

In embodiments, the WTRU may indicate to the network (in the indication regarding deferred RLFs, deferred RLF recoveries, or the detailed information send regarding the deferred RLFs or RLF recoveries) the cause for deferring the RLF detection or recovery (e.g., RLF detection deferred because conditions related to data rate were met, RLF detection deferred because conditions related to mobility level were met, etc.). The WTRU may also include further information such as by how much the RLF detection or recovery was deferred and if the configuration from the network was modified based on WTRU prediction related to mobility level, data rate, trajectory etc. (as discussed in sections 5.2 and 5.3)

In other embodiments, the WTRU may be configured with a maximum time duration for storing information about a deferred RLF detection or RLF recovery.

In embodiments, the WTRU may be configured with a maximum size (e.g., x MBs) that is to be used for storing information about deferred RLF detections or/and RLF recoveries. The WTRU may then delete older entries in the information about deferred RLF detections and recoveries to make room for newer information, if the size of the stored information becomes greater than the specified threshold.

One working example for implementation of the deferred RLF detection may require the WTRU to receive a configuration from the network about radio link management (RLM) and associated radio link failure (RLF) detection. The configuration information may indicate behavior that is dependent on one or more of the radio link (RL) quality of the serving cell, the configured radio bearers and their corresponding QoS settings; the current and predicted data activity level (e.g., UL buffer occupancy, data rate, inactivity level, etc.,) of radio bearers, the mobility/speed of the WTRU, the current time, and the current and predicted WTRU location. The WTRU would further monitor WTRU conditions, such as current and predicted traffic, trajectory, etc. Based on measured or otherwise determined information and settings, the WTRU may modify the RLF detection parameters (e.g., timer values, counters/constants, etc.,) based on the received configuration and current/predicted WTRU and network conditions. The predicted conditions may be based on historical data related to one or more channel conditions and conditions of one or more WTRUs operating within the network. The WTRU may further perform a radio link monitoring based on the modified parameters. During the detection deferral, upon recovery from the link failure before RLF is declared, the WTRU may send an indication to the network indicating that RLF was deferred. Upon request from the network, or included with the indication about a deferred RLF, the WTRU may send details about the deferred RLF (e.g., cause for deferring, time taken to recover link, measurements at the time of failure/recovery, WTRU location at failure/recovery, current time at failure/recovery, etc.)

Another working example for implementation of the deferred RLF recovery, the WTRU may receiving a configuration about radio link management (RLM) and associated radio link failure (RLF) recovery, where the configuration specifies a duration for how long the RLF recovery should be deferred, and the duration is configured to depend on one or more of the radio link quality of the serving cell, the configured radio bearers and their corresponding QoS settings, the current and predicted data activity level (e.g., UL buffer occupancy, data rate, inactivity level, etc.,) of radio bearers, mobility/speed of the WTRU, the current time, and the current and predicted WTRU location. The WTRU may monitor its operating conditions (e.g., current and predicted traffic, trajectory, etc.) and monitor the radio link itself. The WTRU may determine the duration to delay the RLF recovery based on the received configuration and current/predicted WTRU and network conditions. Upon RLF detection, the WTRU may refrain from starting RLF recovery (e.g., re-establishment) for the determined delay duration. Upon recovery from the link failure before the duration delay has elapsed, the WTRU may send an indication to the network indicating that RLF recovery was deferred. Upon request from the network, or included with the indication about a deferred RLF recovery, the WTRU may send details about the deferred RLF recovery (e.g., cause for deferring, time taken to recover link, measurements at the time of failure/recovery, WTRU location at failure/recovery, current time at failure/recovery, the predicted conditions, etc.)

In embodiments, a method and a corresponding apparatus are contemplated for the deferral of RLF detection wherein an WTRU may receive a configuration from the network about RLM and the associated RLF detection. The configuration information may indicate behavior that is dependent on one or more of the RL quality of the serving cell, the configured radio bearers and their corresponding QoS settings; the current and predicted data activity level of radio bearers, the mobility/speed of the WTRU, the current time, and the current and predicted WTRU location. The WTRU may further monitor WTRU conditions, such as current and predicted traffic, trajectory, etc. Based on the measured or otherwise determined information and settings, the WTRU may modify the RLF detection parameters, including timer values, counters/constants, and other parameters, based on the received configuration and current/predicted WTRU and network conditions. The predicted channel conditions and/or the conditions of the WTRU may be based on historical data related to the channel conditions and other WTRUs operating within the network. The WTRU may further perform a RLM based on the modified parameters.

In embodiments, during the RLF detection deferral, upon recovery from the link failure before RLF is declared, the WTRU may send an indication to the network indicating that RLF was deferred. Upon request from the network, or included with the indication about a deferred RLF, the WTRU may send details about the deferred RLF. The details of the deferral may include the cause for deferring, the time taken to recover link, measurements at the time of failure/recovery, the WTRU location at failure/recovery, the current time at failure/recovery and other operational details. In embodiments, in the deferral of RLF recovery, the WTRU may receive configuration information from the network regarding the RLM and the associated RLF recovery.

In embodiments, the configuration information may specify a duration for how long the RLF recovery may be deferred. The configuration specifics may depend on one or more of the RL quality of the serving cell, the configured radio bearers and their corresponding QoS settings, the current and predicted data activity level of radio bearers, mobility/speed of the WTRU, the current time, and the current and predicted WTRU location. The WTRU may monitor its operating conditions, including the current and predicted traffic, trajectory, and other conditions, and monitor the radio link itself. The WTRU may determine the duration to delay the RLF recovery based on the received configuration and current/predicted WTRU and network conditions. Upon RLF detection, the WTRU may refrain from starting RLF recovery (e.g., re-establishment) for the determined delay duration.

In embodiments, during the deferred RLF recovery, upon recovery from the link failure before the duration delay has elapsed, the WTRU may send an indication to the network indicating that RLF recovery was deferred. Upon request from the network, or included with the indication about a deferred RLF recovery, the WTRU may send details about the deferred RLF recovery. The details may include the cause for deferring, the time taken to recover link, measurements at the time of failure/recovery, the WTRU location at failure/recovery, the current time at failure/recovery, and other details.

In embodiments, the methods discussed herein may be implemented in the WTRU, including the monitoring of the quality of the RL of a serving cell of a network node serving the WTRU. The WTRU may receive configuration information from the network, including timer durations and counter values for an RL status determination of the serving cell, and dependency information for the timer durations and counter values based on current and predicted WTRU and network conditions. The WTRU measures or otherwise determines the RL quality of the serving cell and the current WTRU operating conditions and determining predicted conditions. Based on the configuration information and measured or otherwise determined WTRU and network conditions, the WTRU modifies the timer durations and counter values and performs a RL status determination based on the modified timer durations and counter values.

In embodiments, the configuration information may indicate dependency of the timer durations and counter values to one or more of the RL quality of the serving cell, the configured radio bearers of the WTRU and their corresponding QoS settings; the current and predicted data activity level of the WTRU's radio bearers, the mobility/speed of the WTRU, the current time, and the current and predicted WTRU location. In addition, upon recovery from the RLF before expiration of the modified timers and counters, the WTRU may send an indication to the network indicating that the RLF was deferred.

The methods and embodiments described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1-22. (canceled)

23. A method implemented by a remote wireless transmit receive unit (WTRU), the method comprising:
receiving radio link failure (RLF) configuration information from a network, the RLF configuration information comprising a plurality of RLF specific parameters that are used to determine whether RLF has occurred;
determining one or more current and predicted channel conditions of the WTRU;
detecting an RLF specific parameter of the plurality of RLF specific parameters based on the one or more current and predicted channel conditions of the WTRU;
determining one or more channel conditions associated with radio link management (RLM);
determining one or both of RLF detection and RLF recovery behavior based on the detected RLF specific parameter and the one or more current and predicted channel conditions; and
sending an indication to the network based on determining the RLF detection or RLF recovery behavior.

24. The method of claim 23, wherein the one or more current and predicted channel conditions of the WTRU comprises one or more of configured radio bearers, quality of service (QOS) settings of the configured radio bearers, a current data activity level of the configured radio bearers, a predicted data activity level of the configured radio bearers, a mobility state of the WTRU, a speed of the WTRU, a WTRU location, a predicted WTRU location, a WTRU trajectory, or a predicted WTRU trajectory.

25. The method of claim 23, further comprising determining to defer sending the indication to the network based on the detected RLF specific parameter and the one or more current and predicted channel conditions.

26. The method of claim 25, wherein the indication sent to the network indicates that the RLF recovery was deferred.

27. The method of claim 26, further comprising sending RLF information to the network, the RLF information comprising one of more of a deferral cause, a time taken to recover the radio link (RL), one or more channel conditions at the time of RLF, one or more channel conditions at the time of RL recovery, a WTRU location at the time of the RLF, a WTRU location at the time of RL recovery, a time associated with RLF detection, or a time associated with RL recovery.

28. The method of claim 23, wherein the plurality of RLF specific parameters comprise one or more of an RLF counter, an RLF constant, an RLF timer, or an RLF threshold.

29. The method of claim 28, further comprising modifying the detected RLF specific parameter based on the one or more current and predicted channel conditions of the WTRU.

30. The method of claim 23, wherein the one or more determined channel conditions associated with RLM comprise one of more of an RLM reference signal (RLM-RS) or an out of sync indication.

31. The method of claim 23, further comprising determining to perform RLF recovery based on one or more of the one or more determined channel conditions associated with RLM, the one or more current and predicted channel conditions of the WTRU, one or more predicted channel conditions, and one or more predicted conditions of the WTRU, wherein the determining to perform RLF recovery comprises determining whether to defer re-establishment of the radio link.

32. The method of claim 31, further comprising predicting one or more of the channel conditions and the one or more current and predicted channel conditions of the WTRU based on historical data related to one or more channel conditions and one or more current and predicted channel conditions of one or more WTRUs operating within the network.

33. A wireless transmit receive unit (WTRU) comprising:
a processor configured to:
receive radio link failure (RLF) configuration information from a network, the RLF configuration information comprising a plurality of RLF specific parameters that are used to determine whether RLF has occurred;
determine one or more current and predicted channel conditions of the WTRU;
detect an RLF specific parameter of the plurality of RLF specific parameters based on the one or more current and predicted channel conditions of the WTRU;
determine one or more channel conditions associated with radio link management (RLM);
determine one or both of RLF detection and RLF recovery behavior based on the detected RLF specific parameter and the one or more current and predicted channel conditions; and
send an indication to the network based on determining the RLF detection or RLF recovery behavior.

34. The WTRU of claim 33, wherein the one or more current and predicted channel conditions of the WTRU comprises one or more of configured radio bearers, quality of service (QOS) settings of the configured radio bearers, a current data activity level of the configured radio bearers, a predicted data activity level of the configured radio bearers, a mobility state of the WTRU, a speed of the WTRU, a WTRU location, a predicted WTRU location, a WTRU trajectory, or a predicted WTRU trajectory.

35. The WTRU of claim 33, wherein the processor is further configured to determine to defer sending the indication to the network based on the detected RLF specific parameter and the one or more current and predicted channel conditions.

36. The WTRU of claim 35, wherein the indication sent to the network indicates that the RLF recovery was deferred.

37. The WTRU of claim 36, wherein the processor is further configured to send RLF information to the network, the RLF information comprising one of more of a deferral cause, a time taken to recover the radio link (RL), one or more channel conditions at the time of RLF, one or more channel conditions at the time of RL recovery, a location of the WTRU at the time of the RLF, a location of the WTRU at the time of RL recovery, a time associated with RLF detection, or a time associated with RL recovery.

38. The WTRU of claim 33, wherein the plurality of RLF specific parameters comprise one or more of an RLF counter, an RLF constant, an RLF timer, or an RLF threshold.

39. The WTRU of claim 38, wherein the processor is further configured to modify the detected RLF specific parameter based on the one or more current and predicted channel conditions of the WTRU.

40. The WTRU of claim 33, wherein the one or more determined channel conditions associated with RLM comprise one of more of an RLM reference signal (RLM-RS) or an out of sync indication.

41. The WTRU of claim 33, wherein the processor is further configured to determine to perform RLF recovery based on one or more of the one or more determined channel conditions associated with RLM, the one or more current and predicted channel conditions of the WTRU, one or more predicted channel conditions, and one or more predicted conditions of the WTRU, wherein, in determining to perform RLF recovery, the processor is configured to determine whether to defer radio link re-establishment.

42. The WTRU of claim 41, further comprising predicting one or more of the channel conditions and the one or more current and predicted channel conditions of the WTRU based on historical data related to one or more channel conditions and one or more current and predicted channel conditions of one or more WTRUs operating within the network.
